(19) United States
(12) Patent Application Publication
(10) Pub. No.: US 2008/0170592 A1
(43) Pub. Date: Jul. 17, 2008

(54) ALMOST PEER-TO-PEER CLOCK SYNCHRONIZATION

(75) Inventors: Michel H.T. Hack, Cortlandt Manor, NY (US); Zhen Liu, Tarrytown, NY (US); Ahmed A. Sobeih, Champaign, IL (US); Li Zhang, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/622,177

(22) Filed: Jan. 11, 2007

(51) Int. Cl. H04J 3/06

(52) U.S. Cl. 370/503; 370/401

(57) ABSTRACT

Disclosed are a method of and a system for synchronizing clocks in a coordinated network of computers including a multitude of processing nodes, each of the nodes having a clock and one or more neighbor nodes. The method comprises the steps of electing one of the nodes as a correct leader node; and each of the non-leader nodes adjusting its clock rate, based on messages exchanged with neighbor nodes, to remain synchronized with the clock of said correct leader node. In a preferred embodiment, the adjusting step includes the step of each of the non-correct leader nodes using a weight assignment mechanism that gives neighbor nodes that are closer to the leader node more effect on the clock adjustment than those nodes that are further away from the correct leader node.

### BACKGROUND OF THE INVENTION

1. Field of the Invention

This invention generally relates to clusters or networks of computers, and more specifically, the invention relates to clock synchronization in a cluster of computers. Even more specifically, the preferred embodiment of the invention relates to clock synchronization in a cluster of servers.

2. Background Art

Clock synchronization is important for a wide variety of applications; e.g., banking transactions, log management, bandwidth usage and network fault detection. For instance, some routers use the Network Time Protocol to compare time logs, which is essential for tracking security incidents, analyzing faults and troubleshooting. In multi-hop wireless ad hoc networks, clock synchronization is necessary for several operations; e.g. power management and frequency hopping in the IEEE 802.11 standard. In wireless sensor networks, information dissemination paradigms require time synchronization.

As used herein, clock synchronization refers to the mechanisms and protocols used to maintain mutually consistent time-of-day clocks in a coordinated network of computers. The intent is to provide the illusion of a global time-of-day clock that is strictly monotonic as observed by any node in the network: if, at time T₁, node A asks node B to report its current time T₂, and the reply is received at node A at time T₃, then one would like to guarantee that T₁<T₂<T₃.

The consistency requirement stated above is stronger than the need to provide the “correct” time to within some specified error bounds, since the inequalities are supposed to be strict. What really matters is not the offset of each clock to true time, but whether the relative offset between any pair of clocks is smaller than the minimum communication delay between the corresponding nodes: if that is achieved, programs will not be able to observe inconsistent timestamps.

The consistency requirement is in fact so strong that it is difficult to guarantee (i.e., prove that it holds, given reasonable constraints on external steering and delay variance). When data integrity depends on it, a separate mechanism is needed to enforce consistency. For example, Message Time Ordering Facility (MTOF), provided by the International Business Machines Corporation (IBM), delays delivery of a message (if necessary) until the receiver's clock has caught up with the sender's timestamp. The goal of clock synchronization is then to avoid triggering MTOF (which does have an effect on performance) as much as possible.

One solution is for every node to get its time from a single source, using stable delay-compensated links (after an initial tuning sequence, programmable delay lines are adjusted so that timing pulses arrive at each node within microseconds of each other): this is the Sysplex Timer® mechanism used in IBM's zSeries Parallel Sysplex®.

Another solution would be for each node to be attached to a GPS receiver. For a fixed location, with at least four Global Positioning Systems satellites in view for a sufficient settling period, microsecond accuracy can be achieved. Unfortunately signal outages are common, and it does not take long for ordinary oscillators to drift by tens of microseconds.

A distributed way to achieve mutual synchronization is to use timestamped message exchanges over the same (or better) links than are used for communication. The usual four-timestamp method of NTP (Network Time Protocol) permits the offset between sender and receiver to be computed, assuming symmetric forward and backward communication delays.

One node can then steer its clock to absorb any offset (adjust to its clock source). The literature warns against clock dependency loops, however, which is why most synchronization networks use a stratified approach starting from a Primary Reference Clock (called “Stratum-1”), using “Peer” mode at best to obtain a smoother clock in an environment with high link delay variance. Indeed, one can construct pathological cases of clock dependency loops where each clock thinks it is slower than its neighbor (it caught its neighbor during overshoot of a correction phase to react to an earlier perceived slowness), with the net effect that the entire network “takes off” (at least until a saturation point is reached).

Stratified systems require explicit configuration, however, at least with respect to designating the Stratum-1. In order to deal with node failures, a recovery mechanism (typically also preconfigured) must be in place to avoid global failure. In a Peer-to-Peer system, as long as the network remains connected, surviving nodes can still synchronize with each other. The question is, does this resilience come at the expense of possible instability problems?

Peer-to-Peer (P2P) synchronization schemes have been tried in the past, but may have stability problems due to circular clock dependencies. An example is STP, which will be presented in more detail later. P2P systems do however enjoy a high level of fault tolerance without complicated failover mechanisms, because as long as the timing network remains connected, surviving nodes can still synchronize to each other.

It would thus be highly desirable to provide a clock synchronization in a coordinated network of computers that achieves natural fault tolerance as in P2P with the stability of a hierarchical approach like STP.

### SUMMARY OF THE INVENTION

An object of this invention is to improve clock synchronization in a coordinated network of computers.

Another object of the present invention is to provide a clock synchronization, in a coordinated network of computers, that retains the resilience of a fully distributed peer-to-peer synchronization network with the stability guarantees of a hierarchical synchronization network.

A further object of the invention is to provide a clock synchronization, in a coordinated network of computers, in which a unique node is elected as a leader in a distributed manner, and where each non-leader node adjusts its clock steering rate based on message exchanges with its neighbors.

Another object of this invention is to provide a clock synchronization, in a coordinated network of computers, that makes use of a weight assignment mechanism that gives neighbors that are closer to a leader node more effect on the clock adjustment than those that are further away from the leader node.

These and other objectives are attained with a method of and system for synchronizing clocks in a coordinated network of computers including a multitude of processing nodes, each of the nodes having a clock and one or more neighbor nodes. The method comprises the steps of electing one of the nodes as a correct leader node; and each of the non-leader nodes adjusting its clock rate, based on messages exchanged with neighbor nodes, to remain synchronized with the clock of said leader node. There is one “correct” leader among the live nodes in a connected network, determinable from node Ids and exchanged sequence numbers, and this one node will end up being the one and only leader when the election process stabilizes.

In a preferred embodiment, the adjusting step includes the step of each of the non-leader nodes using a weight assignment mechanism that gives neighbor nodes that are closer to the leader node more effect on the clock adjustment than those nodes that are further away from the correct leader node. Also, in this preferred embodiment, the electing step includes the steps of each of the nodes identifying one of the nodes as the correct leader node; passing messages with leader identification information between the nodes; and one or more of the nodes changing their identification of the leader node based on said messages passing between the nodes, until all of the nodes agree on one of the nodes as the correct leader node.

The present invention uses a P2P time synchronization protocol (where each node tracks all others in some manner), with the following added feature: one node, called the current leader, does not adjust its clock. Stability is guaranteed by the fact that the leader's clock enjoys at least its natural stability (which, in mainframe systems at least, is usually reasonably good: +/−2 ppm short term, with long-term correction applied by occasional steering to an external time reference), and all others will not drift too far relative to the current leader because all try to minimize their relative offsets.

An important aspect of the preferred embodiment of the invention is to make sure that there is exactly one leader, and everybody knows the identify of the leader. When links fail but the leader remains accessible (over some path—it is assumed that the network remains connected, and has sufficient physical link redundancy), leadership need not change, but when the leader dies (or goes silent for too long), another node should declare itself the new leader. This can lead to transient states with no leader, or more than one leader, but the leadership election algorithm detailed below will converge in bounded time to a single known-to-all new leader. This is what preserves the fault tolerance of a P2P timing network, without giving up the stability of a hierarchical timing network.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows code for a procedure for ensuring that all nodes end up agreeing on a common leader.

FIGS. 2(a)-2(c) show a network of a tree topology with three strata, and synchronization accuracy for STP and AP2P for this network.

FIGS. 3(a)-3(c) illustrate P2P, AP2P and STP accuracy comparisons.

FIGS. 4(a) and 4(b) show the relative offset between a pair of clocks vs. the shortest distance (in number of links) between the corresponding nodes.

FIGS. 5(a)-5(e) compare the performance of STP with that of AP2P in terms of recovery from node failure for a network topology having eight nodes, as shown in FIG. 5(a).

FIG. 6 is a diagram of a computer system, which may be used in the practice of this invention.

### DETAILED DESCRIPTION OF THE PREFERRED EMBODIMENTS

### Hierarchical Clock Synchronization (STP)

The following description presents the protocol with which the embodiment will be contrasted.

The successor to IBM's Sysplex Timer® solution is the Server Time Protocol (STP), announced in July 2005. It uses a stratified message-based mechanism similar to NTP, using Coupling-Facility links (the links used in a zSeries Parallel Sysplex®). Clock steering is available at the zSeries hardware level, and sophisticated filtering algorithms are used to extract relative clock offset and skew, from which a clock steering rate is derived. Recoverability is achieved by pre-configuring an alternate Stratum-1 server, and enhanced by a so-called “triad” configuration where a third server is designated as an arbiter that can assist in discriminating link failures from node failures, so as to permit a swift Stratum-1 takeover when warranted.

Unlike NTP, the communication paradigm is that of a direct response to a command. In STP, a node periodically exchanges timing packets with each of its neighbors; i.e., the other nodes that it is directly connected to. Each exchange provides a set of four time stamps, the first (A:sent) and last (A:rcvd) derived from the local clock, and the middle two (B:rcvd and B:sent) derived from the remote clock. Round-trip delay and Offset samples are derived from this, but unlike NTP, the reported values are based on filtering applied to a sliding window of recent exchanges, using an algorithm based on the Convex Hull method. This also provides a good estimate of the skew between nodes A and B.

A clock selection algorithm selects exactly one of the attached servers to be the clock source, taking stratum into account, so as to eliminate clock dependency loops. From the skew and offset relative to the clock source, a node computes a steering rate adjustment so as to steer the local clock towards agreement with the clock source.

### Almost Peer-to-Peer (AP2P) Clock Synchronization

In contrast to the hierarchical approach of STP, the present invention provides an “Almost Peer-to-Peer” clock synchronization mechanism, referred to as AP2P. It is assumed that each node, n, has a unique numeric ID, IDₙ. It is also assumed that each node knows the set of its neighbors, Gₙ; i.e., the other nodes that it is directly connected to. A node does not need to know the entire network topology. It is, however, not assumed that the network is connected.

As in STP, each node periodically exchanges timing packets with its immediate neighbors, from which it obtains the four timestamps and four other items, described below. Offset and Skew are determined by clock filtering, but unlike STP, the steering correction takes all neighbors into account (like Peer-to-Peer), but not necessarily uniformly, and there is a specific difference from pure Peer-to-Peer (hence “Almost”): A node which considers itself to be the Leader does not adjust its clock rate.

Leadership election is therefore a critical component of AP2P. It is however quite different from traditional Leadership Election because transient states with no Leader, or with more than one, are benign (as long as they do not last too long). The main difference is the fact that, in AP2P, it is not required that everybody know that everybody knows the new leader. This greatly reduces the complexity of the algorithm, and completely avoids the non-linear communication overhead in many of the traditional mechanisms.

### Leader Election Mechanism

Exactly one of the nodes is the correct leader. In the steady-state case, all of the nodes agree on the identity of the unique correct leader. Transient states may exist where either (i) only a subset of the nodes agree on the identity of the unique correct leader, or (ii) the “old” correct leader has failed, and no node has taken over the leadership yet. Note that link failures, which do not disconnect the leader from the rest of the network, do not lead to transient states.

A leader plays a role that is similar to a stratum-1 node in STP in the sense that it does not adjust its clock rate based on the timing message exchanges. The other nodes adjust their clock rates in order to remain as synchronized as possible; this is described below.

Let CL(t) denote the correct leader at time t. Each node, n, maintains the following four fields at time t:
1. Lₙ(t): the ID of the node which n thinks is the leader at time t. Note that n considers itself a leader if and only if Ln(t)=IDₙ, and n knows the identity of the correct leader if and only if Ln(t)=CL(t).
2. seqₙ(t): a sequence number for Ln(t). It indicates how “up-to-date” the leadership information Lₙ(t) is.
3. dₙ(t): the shortest distance (in terms of the number of links) from Ln(t). If n considers itself a leader (i.e., Lₙ(t)=IDₙ), then dₙ(t)=0. (This field is not used for leader election, but is used in the clock synchronization mechanism explained below).
4. stampₙ(t): the current local timestamp inserted by Lₙ(t) in its outgoing Timing packets, according to Lₙ(t)'s clock. (This field is not used for leader election, but is used in recovery from node and link failures as will be explained below).

Each timing packet, p, identifies its sender, sender(p), and carries <Lₚ, seqₚ, dₚ, stampₚ> which is a copy of the corresponding four-tuple stored at sender(p) at the time the packet is sent. If the sender considers itself to be the leader, it refreshes its stamp from its local Logical Clock before copying it to stampₚ.

The initial values of the sequence numbers (i.e., ∀iεN, seqᵢ(t₀), where N is the set of nodes and t₀ is the system initialization time) can be either chosen randomly from a certain domain of valid sequence numbers or configured by a system administrator. Initially at least one node considers itself a leader (i.e., ∃iεN,Lᵢ(t₀)=IDᵢ). A node, i, which does not initially consider itself a leader, sets its Lᵢ(t₀) to—∞ (practically, any value that is guaranteed to be larger than any valid node ID) and its seqᵢ(t₀) to—∞ (practically, any value that is guaranteed to be smaller than any valid sequence number). Afterwards, Lᵢ(t) and seqᵢ(t) are updated in only two cases: (1) receiving an incoming packet, and (2) recovering from node failures (this case will be discussed below).

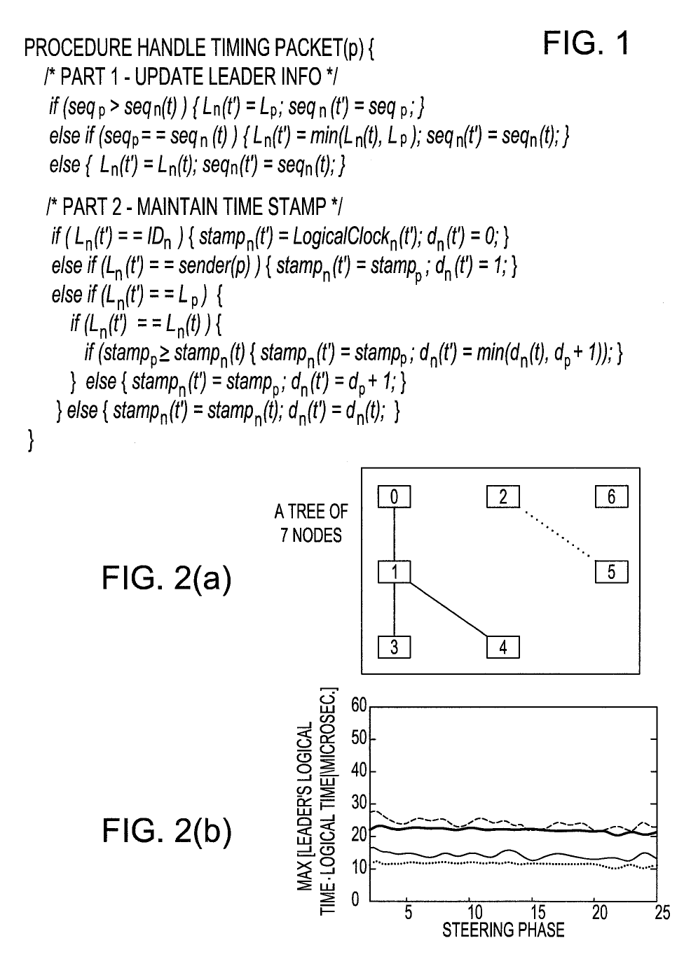

The correct leader CL(t) at time t is: CL(t)=L_{i*}(t), where i*=arg maxᵢε_{N}seqᵢ(t). In other words, the highest sequence number “wins”, and the unique node IDs are used as tiebreakers to assure global uniqueness. Given that nodes are assumed to exchange timing packets on a regular basis, and that each timing packet includes the fixed-size (four-item) information used for leader determination, a simple algorithm permits all nodes to end up agreeing on a common leader from any starting condition that includes at least one leader. There is no specific “election” phase—leadership determination is an ongoing distributed process, so it can quickly react to any changes. FIG. 1 shows the algorithm for procedure HandleTimingPacket(p):

This algorithm runs whenever a node n receives a timing packet p from a neighbor sender(p). The node will compute a new four-tuple <Lₙ(t′), seqₙ(t′), dₙ(t′), stampₙ(t′)> from the current four-tuple <Lₙ(t), seqₙ(t), dₙ(t), stampₙ(t)> and the four-tuple included in the packet <Lₚ, seqₚ, dₚ, stampₚ> (sent by sender(p)).

The first part of HandleTimingPacket(p) implements the propagation of leadership information: if the packet's sequence number is larger than the node's current sequence number, or if the numbers are equal but the packet's leader ID is lower than the node's recorded leader ID, the packet's sequence number and leader ID are accepted as the new values to be recorded at this node. It is important to note that a node does not voluntarily claim that another node is the leader.

Essential properties of the procedure are established by the following two theorems.

Theorem 1: All the nodes in the network will eventually agree on the
identity of the unique correct leader.

Proof: Define f(t) as the number of nodes whose leader ID is equal to the identity of the correct leader at time t. The following discussion proves that this function is non-decreasing and will reach |N|, the number of nodes in the timing network. Specifically, f(t)=|{iεN,Lᵢ(t)=CL(t)}|.

Note that 1≦f(t)≦|N| (initially at least one node considers itself a leader). Exactly one of those nodes that initially consider themselves as leaders (namely the one with the largest sequence number and, in case of ties, smallest leader ID) is the correct leader; hence, initially there exists exactly one node, i*εN, such that L_{i*}(t₀)=ID_{i*}=CL(t₀).

Every timing packet reception either increases f(t) or keeps it constant. To see why, consider the following two cases for a node n that has sent Timing Request packets to all its neighbors, Gₙ, at time t and has received Timing Response packets from all of them at time t′:

Case A: If neither n nor any of its neighbors has its leader ID set to CL(t), then neither n nor any of its neighbors will discover the identity of the correct leader after the Timing message exchange. Hence, f(t) remains constant; i.e., f(t′)=f(t).

Case B: If either n or at least one of its neighbors has its leader ID set to CL(t), then there are two subcases:

Case B-1: If Lₙ(t)=CL(t), and k of n's neighbors do not know the identity of the correct leader, then all of the k neighbors will set their leader IDs to CL(t) after they receive the Timing Request packets from n; hence, f(t′)=f(t)+k.

Case B-2: If Lₙ(t)≠CL(t), and at least one of n's neighbors has its leader ID set to CL(t), then n will set its leader ID to CL(t) after it receives the Timing Response packet from that neighbor; hence, f(t′)=f(t)+1.

Assuming that each node gets a chance to participate in the leader election mechanism (this assumption is reasonable because the leadership information is carried in the Timing packets that nodes are exchanging periodically in order to achieve clock synchronization), this ensures that neither Case A nor Case B-1 with k=0 will be the case forever; hence, f(t) will increase until it eventually reaches |N|. f(t)=|N| means that ∀iεN,Lᵢ(t)=CL(t). Hence, after f(t)=|N|, neither

Case A nor Case B-2 may happen. The only possible case will be Case B-1 with k=0 (because all of n's neighbors already know the identity of the correct leader). Therefore, once f(t) reaches |N|, f(t) will remain constant. This completes the proof.

It should be mentioned that using sequence numbers gives system administrators the ability to pre-determine the leader of a network (e.g., because this node has access to a good external time reference). A system administrator simply needs to assign this node a sequence number that is strictly larger than the sequence number of any other node in the network, and configure this node to initially consider itself a leader. Similarly, in order to prohibit a node from being the leader of a network, a system administrator simply needs to assign this node a sequence number that is strictly smaller than the sequence number of at least one other node in the network.

To accelerate propagation of leadership change, a node that just updated its recorded Leader ID will immediately send a LEADER packet to each of its neighbors (instead of waiting for the next scheduled timing exchange). Such a packet p contains only its sender ID and the four leadership information fields: <Lₚ, seqₚ, dₚ, stampₚ>. It is processed just like any other packet with regard to this information. System Initialization time counts as a change in Leadership for those nodes that initially consider themselves to be a leader (there is at least one).

Theorem 2: Regardless of how many nodes initially declare themselves
as leaders, all the nodes in the network will agree on the identity of the
unique correct leader after D × P from the system initialization time
t₀, where D is the maximum shortest distance (in terms
of the number of links) from the correct leader to any node, and P is the
maximum propagation delay of a link.

Proof: Recall that, regardless of how many nodes initially declare themselves as leaders, exactly one of them (namely the one with the largest sequence number and, in case of ties, smallest leader ID) is the correct leader. This discussed only needs to consider the LEADER packets sent by this correct leader (identified as i* below).

After P from the time i* sends the LEADER packet, all of the nodes that are direct neighbors of (i.e., one link away from) i* will have received the LEADER packet. All of these direct neighbors will accept the leadership information contained in the LEADER packet. This is because i* has a larger sequence number (or, in case of ties, a smaller leader ID) than that of any other node in the network (that is the definition of the correct leader). Furthermore, for each node jεGi*, node j's leader ID will change after handling the LEADER packet. This is because j has no other way of previously knowing that i* is a leader (recall that no node voluntarily claims that another node is the leader). Hence, node j will forward a LEADER packet to each of its neighbors.

After 2×P from the time i* sends the LEADER packet, a similar argument can be stated for all the nodes whose shortest distance (in terms of the number of links) from i* is 2. In general, after d×P, all the nodes whose shortest distance from i* is d will agree on the identity of the correct leader i*. Hence, if D is the maximum shortest distance from i* to any node, all the nodes in the network will agree on the identity of the unique correct leader after D×P. This completes the proof.

Note that at t₀+D×P, ∀nεN,Lₙ(t₀+D×P)=i*; hence, the forwarding of LEADER packets will stop because no node will have its leader ID changed after handling a LEADER packet. In fact, it is easy to see that each node will send a LEADER packet, declaring i* as a leader, to each of its neighbors exactly once. Hence, the overhead caused by broadcasting LEADER packets is insignificant. It should also be noted that if LEADER packets are lost, agreement on the identity of the unique correct leader will only be delayed, but will eventually be achieved (as proved in Theorem 1) because leadership information is carried in all Timing packets that are exchanged between the nodes.

### Clock Synchronization Mechanism

Periodically every outgoing message command interval τ, node n sends a Timing Request packet to each of its neighbors. Upon receiving a Timing Response packet from a neighbor, n runs the convex hull-filtering algorithm to compute a suggested change in its steering rate, and records it in a small history array. It then computes the total change in its steering rate as a weighted average of the recent steering rate changes computed for its neighbors. (If a neighbor does not reply after a reasonable timeout, e.g. three times the estimated round-trip delay (available from the filter computation), the steering correction can be computed from the remaining information, and the age of the current leadership information can be checked.)

The weight assigned to each suggested steering rate change depends on the distance d to leader (reported as dₚ in a Timing Response packet p), and on whether the reported Leader ID Lₚ agrees with the node's own view thereof, Lₙ: if not equal, a weight of zero is assigned (the information is not believed), otherwise a weight of b^{-d} is assigned, where the base b≧1 can be tuned to control the ratio between the weight assigned to a closer node to that assigned to a further node. In fact, an exponentially weighted moving average is used for each neighbor, so that more recent steering suggestions have more effect than older ones.

Recovery from Node and Link Failures

The most important type of node failure is the failure of the current leader. In this case, another node has to take over the leadership by becoming the new leader. Furthermore, it would be better if one of the nodes that were direct neighbors of the “old” leader became the new leader: such a node is most likely better synchronized with that leader's clock than nodes that are further away. This preference is not absolute, however, since one would like to handle the case where a dead leader's direct neighbors fail before having assumed leadership and propagated that information. Instead, any node can be the new leader, with the nodes that were closer to the old leader having a better chance of being the new leader.

Similarly, the most important type of link failure is the failure of a link that is connected to the current leader (but not the last such link—it is assumed that there is enough link redundancy so that the timing network remains connected). In this case, a leadership change is not wanted because the current leader is still operating and did not fail.

In summary, a mechanism is needed that discovers a leader's failure and differentiates between a node failure and a link failure. This is where the leader timestamps recorded at each node (stampₙ) and transmitted in each packet (stampₚ) come into play. Recall that this timestamp is updated whenever a node that considers itself to be the Leader sends out a Timing packet (Request or Response).

Now is the time to examine the second part of HandleTimingPacket(p). When n is a direct neighbor of the leader, it accepts the new timestamp, which is guaranteed to be more up-to-date than that stored at the node, because it comes from the leader itself. Otherwise, if n is not a direct neighbor of the leader, it needs first to check whether the packet timestamp is more up-to-date than its own. This check is only required if n did not change its leader ID—if not, the source clocks are not comparable, and the new timestamp should be accepted unconditionally (it might be from a node about to become a new leader).

It is now easy to see that if a link that is connected to the current leader failed, the leader timestamps can still be propagated in the network as long as the current leader is still connected to the network. These timestamps are used to detect the current leader's failure and trigger a leadership change: If the leader timestamp, stampₙ(t), is not refreshed for dₙ(t)×T (where T is a parameter of the recovery mechanism), n considers the current leader to have failed, and declares itself as a leader. Specifically, n sets its leader ID Lₙ(t) to its own ID IDₙ, its dₙ(t) to 0, its stampₙ(t) to its local logical clock, and increments its seqₙ(t). Incrementing seqₙ(t) is required so that nodes accept the new leader's information and discard that of the old leader. Furthermore, n broadcasts a LEADER packet declaring itself as a leader, as described in Section 3.1.

It should be noted that multiple nodes may detect the old leader's failure (almost) simultaneously and declare themselves as new leaders. In this case, the conflict will be resolved by the leader election mechanism discussed above. As we proved in Theorems 1 and 2, this mechanism guarantees that all the nodes in the network will eventually agree, within a finite time, on the identity of a new unique correct leader.

### Performance Evaluation Results

A performance evaluation was carried out using the J-Sim network simulator. For the most part the evaluation used is the traditional measure of maximum offset from a common reference, but an example is included of almostperfect synchronization, where MTOF could induce small extra delays during sharp steering events.

Different network topologies were used in the experiments. The link delays follow different distributions including Pareto, log-Normal and Exponential distributions. Very similar patterns were observed for different distributions. Herein, only present results are presented for Pareto link delay distributions, with parameter k and minimum value 10 μs. Smaller values of k correspond to links with larger delay variations.

The most severe challenge to maintaining synchronization is when the Leader changes its clock rate—e.g. to track some external time reference. It may take a few seconds for the network to adjust—this is called the “steering phase” of the reaction (as opposed to the “normal phase”).

### Clock Synchronization Accuracy

The maximum deviation between a clock and the leader's clock is used as the measure for the synchronization accuracy. Because each clock in the AP2P mechanism is influenced by other neighboring clocks that may have less up-to-date information from the leader, the synchronization accuracy of AP2P may be worse compared with a hierarchical approach such as STP.

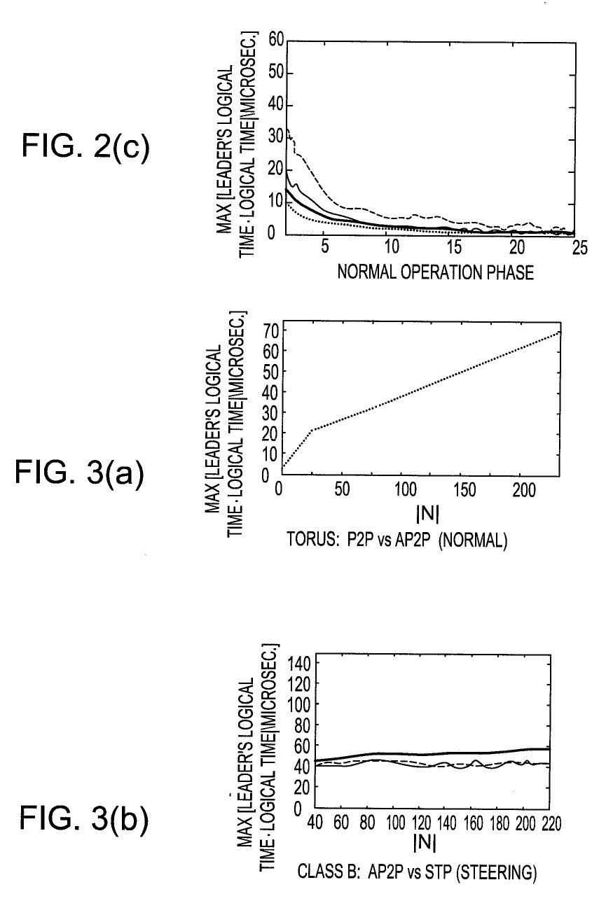

Consider first the network of a tree topology with three strata, as shown in FIG. 2(a). Node 0 (the stratum-1 node in the STP case) starts as the leader. This is achieved by initially assigning node 0 the largest sequence number in the network, and making node 0 declare itself as a leader. It changes its steering rate three times: from 0 ppm to 25 ppm at time 50 second, to −25 ppm at time 100 second and to 0 ppm at time 150 second. A node exchanges 16 messages per second with each of its neighbors. The steering phase (see above) starts whenever node 0 changes its steering rate, and lasts for five seconds thereafter.

FIGS. 2(b) and 2(c) show the maximum deviation from the leader's clock for stratum 2 and 3 nodes. The horizontal axis k corresponds to the shape parameter for the Pareto distribution. Each data point is the average of 10 simulation runs. It can be observed that the synchronization accuracy degrades for smaller k, which corresponds to more variable link delays. Furthermore, in normal operation phase, the accuracy is often within the average link delay. In the steering phase, the accuracy is roughly d times the average link delay for stratum—(d+1) nodes. This corresponds to the propagation delay of the steering information from node 0 to the stratum 2 and 3 nodes.

### Clock Dependency Loops

To evaluate the performance of various clock synchronization mechanisms for more complex network topologies with dependency loops, we first compare the performance of AP2P is first compared with that of a purely peer-to-peer clock synchronization protocol (referred to as P2P). In P2P, there is no leader, and each node assigns an equal weight to each of its neighbors (base b=1). Consider a set of network topologies; each of which is a 2-D torus of |N| nodes. In such networks, as |N| increases, the maximum shortest distance (in terms of the number of links) between two nodes increases but the number of neighbors of a node remains constant.

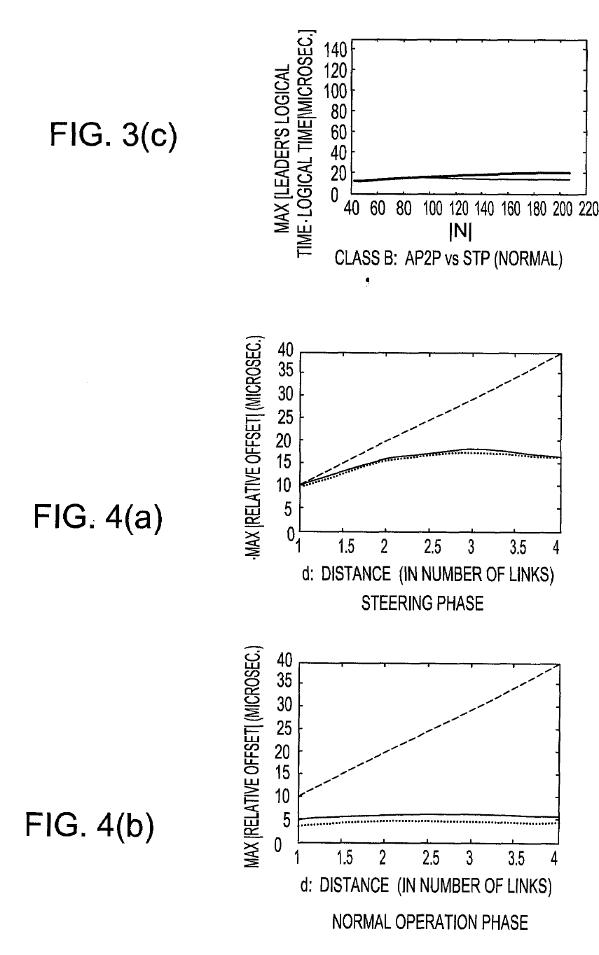

A node, 1, is chosen uniformly at random to be the leader node in the case of AP2P. In both P2P and AP2P, the maximum deviation of the logical clocks of all nodes from the logical clock of node 1 is measured. As shown in FIGS. 3(a) to 3(c), the synchronization accuracy for P2P is almost two times worse than AP2P. This result demonstrates the significant benefit for the leader election mechanism.

Next, the performance of AP2P and STP for larger size networks is compared. The GT-ITM network topology generator may be used to generate more realistic networks. Consider two types of networks: non-hierarchical (referred to as Class A), and hierarchical (referred to as Class B).

FIGS. 3(a) to 3(c) show the maximum deviation from the leader's clock for the stratum-7 nodes for the Class B network topologies in both the steering and normal operation phases. The performance of AP2P with b=2 is considerably worse than that of STP but, as b increases, the effect of neighbors further away from the leader diminishes, and accuracy improves. In particular, in the steering phase, the performance of AP2P with b=100 is very close to that of STP, and in the normal operation phase it is already indistinguishable from that of STP for b=10. Similar results were obtained at the other strata and for Class A networks. This result justifies the need for a weight assignment mechanism that strongly favors neighbors that are closer to the leader.

### Relative Offset Between Pairs of Clocks

Presented below is a discussion of the maximum absolute relative offset between a pair of clocks versus the minimum communication delay between the corresponding nodes. The network topology is a grid of 9 nodes. A node, 1, is chosen uniformly at random to be the stratum-1 (or leader) node for STP (or AP2P).

FIGS. 4(a) and 4(b) show the maximum absolute relative offset between a pair of clocks vs. the shortest distance (in number of links) between the corresponding nodes. As shown in FIG. 4(b), in the normal operation phase, the maximum absolute relative offset between a pair of clocks, whose nodes are at a shortest distance of d links from each other, is less than d*10 μs. In the steering phase (FIG. 4(a)), this is satisfied except for some immediate neighbors d=1, where AP2P just barely manages to avoid MTOF delays, and STP is likely to incur occasional MTOF delays on the order of 1 μs at the onset of external steering. (The moral is to avoid abrupt external steering changes—the desired effect can usually be achieved by a more gradual approach.)

### Failure Recovery

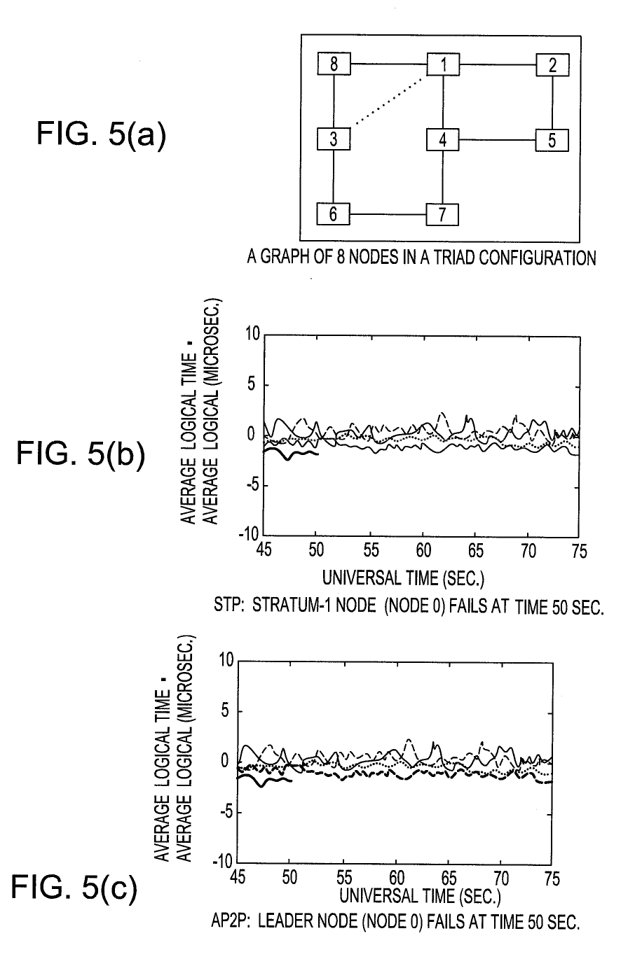

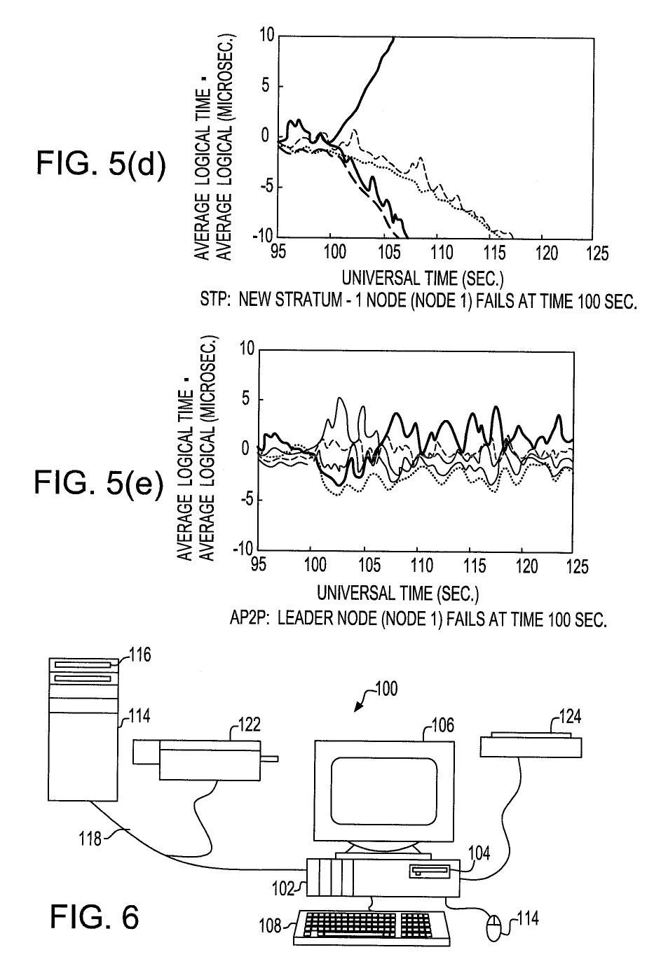

The performance of STP is compared with that of AP2P in terms of recovery from node failures. The link failure cases have same types of behavior. Consider the case of two consecutive stratum-1 (or leader) node failures. The network topology consists of eight nodes, as shown in FIG. 5(a), with a link between node 1 (the alternate stratum-1 server in STP) and node 3 (the arbiter server in STP) as required by the triad configuration in STP. At time 50 sec., node 0 fails, causing another node to become the new stratum-1 (or leader) node, as shown in FIG. 5(b) and FIG. 5(c). At time 100 sec., the new stratum-1 (or leader) node fails. In the case of STP, the remaining nodes are not able to maintain synchronization, as shown in FIG. 5(d), although the network is still connected. In fact, the triad configuration in STP cannot handle this type of two consecutive stratum-1 node failures. In contrast, the leader election mechanism in AP2P enabled the remaining nodes to elect a new leader and continue to maintain synchronization, as shown in FIG. 5(e).

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

For example, FIG. 6 depicts a computer system 100 that may be used in the practice of the present invention. Processing unit 102 houses a processor, memory and other systems components that implement a general purpose processing system that may execute a computer program product comprising media, for example a floppy disc that may be read by processing unit 102 through floppy drive 104.

The program product may also be stored on hard disk drives within processing unit 102 or may be located on a remote system 114 such as a server, coupled to processing unit 102, via a network interface, such as an Ethernet interface. Monitor 106, mouse 114 and keyboard 108 are coupled to processing unit 102, to provide user interaction. Scanner 124 and printer 122 are provided for document input and output. Printer 122, is shown coupled to processing unit via a network connection, but may be coupled directly to processing unit 102. Scanner 124 is shown coupled to processing unit 102 directly, but it should be understood that peripherals may be network coupled or direct coupled without affecting the ability of workstation computer 100 to perform the method of the invention.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of synchronizing clocks in a coordinated network of computers including a multitude of processing nodes, each of the nodes having a clock and one or more neighbor nodes, the method comprising the steps of:
electing one of the nodes as a correct leader node; and
each of the non-leader nodes adjusting its clock rate, based on messages exchanged with neighbor nodes, to remain synchronized with the clock of said correct leader node.

2. A method according to claim 1, wherein said adjusting step includes the step of each of the non leader nodes using a weight assignment mechanism that gives neighbor nodes that are closer to the correct leader node more effect on the clock adjustment than those nodes that are further away from the correct leader node.

3. A method according to claim 1, wherein the electing step includes the steps of:
each of the nodes identifying one of the nodes as the correct leader node;
passing messages with leader identification information between the nodes; and
one or more of the nodes changing their identification of the correct leader node based on said messages passing between the nodes, until all of the nodes agree on one of the nodes as the correct leader node.

4. A method according to claim 3, wherein:
the identifying step includes the step of each node of at least some of the nodes identifying itself as a correct leader node;
the passing step includes the step of each of the nodes that identifies itself as a correct leader node, broadcasting a leader packet that identifies itself as a correct leader node; and
the changing step includes the step of the nodes using the leader packets to converge to an agreement on one of the nodes as the correct leader node.

5. A method according to claim 1, wherein the electing step includes the steps of:
assigning each of the nodes a sequence number; and
electing one of the nodes as the leader node based on the sequence numbers assigned to the nodes.

6. A method according to claim 1, comprising the further steps of:
under steady state conditions, the correct leader node broadcasting a packet at defined times identifying itself as the correct leader node; and
if the non-leader nodes do not receive said packet within a defined period of time, the non-leader nodes electing a new correct leader node.

7. A method according to claim 6, wherein the step of electing a new correct leader node includes the steps of:
each of the nodes maintaining a time stamp, and each node refreshing its time stamp each time the node receives said packet; and
if the time stamp of one of the nodes is not refreshed within said defined period of time, said one of the nodes identifying the current leader node as failed.

8. A method according to claim 7, wherein the step of electing a new correct leader node includes the step of, if the time stamp of one of the nodes is not refreshed within said defined period of time, said one of the nodes identifying itself as the new correct leader.

9. A system for synchronizing clocks in a coordinated network of computers, the system comprising:
a multitude of processing nodes, each of the processing nodes having a clock; and
said processing nodes configured for
electing one of the nodes as a correct leader node; and
each of the non-leader nodes adjusting its clock rate, based on messages exchanged with neighbor nodes, to remain synchronized with the clock of said correct leader node.

10. A system according to claim 9, wherein said processing nodes are further configured for, each of the non-leader nodes using a weight assignment mechanism that gives neighbor nodes that are closer to the correct leader node more effect on the clock adjustment than those nodes that are further away from the correct leader node.

11. A system according to claim 9, wherein the nodes are configured so that the electing is done by:
each of the nodes identifying one of the nodes as the correct leader node;
passing messages with leader identification information between the nodes; and
one or more of the nodes changing their identification of the correct leader node based on said messages passing between the nodes, until all of the nodes agree on one of the nodes as the correct leader node.

12. A system according to claim 11, wherein the nodes are configured so that:
the identifying is accomplished as a result of each node, of at least some of the nodes, identifying itself as a correct leader node;
the passing is accomplished as a result of each of the nodes that identifies itself as a correct leader node, broadcasting a leader packet that identifies itself as a correct leader node; and
the changing is done by using the leader packets to converge to an agreement on one of the nodes as the correct leader node.

13. A system according to claim 9, wherein the nodes are configured so that the electing is done by:
assigning each of the nodes a sequence number; and
electing one of the nodes as the leader node based on the sequence numbers assigned to the nodes.

14. A method according to claim 9, wherein the processing node are further configured for:
under steady state conditions, the correct leader node broadcasting a packet at defined times identifying itself as the correct leader node; and
if the non-leader nodes do not receive said packet within a defined period of time, the non-leader nodes electing a new correct leader node.

15. A program storage device readable by machine, tangibly embodying a program of instructions executable by the machine to perform a method of synchronizing clocks in a coordinated network of computers including a multitude of processing nodes, each of the processing nodes having a clock, the method comprising the steps of:
electing one of the nodes as a correct leader node; and
each of the non-leader nodes adjusting its clock rate, based on messages exchanged with neighbor nodes, to remain synchronized with the clock of said correct leader node.

16. A program storage device according to claim 15, wherein said adjusting step includes the step of each of the non-leader nodes using a weight assignment mechanism that gives neighbor nodes that are closer to the correct leader node more effect on the clock adjustment than those nodes that are further away from the correct leader node.

17. A program storage device according to claim 15, wherein;
the electing step includes the steps of
i) each of the nodes identifying one of the nodes as the correct leader node,
ii) passing messages with leader identification information between the nodes, and
iii) one or more of the nodes changing their identification of the leader node and sequence number based on said messages passing between the nodes, until all of the nodes agree on one of the nodes as the leader node;
iv) the identifying step includes the step of each node of at least some of the nodes identifying itself as a correct leader node;
v) the passing step includes the step of each of the nodes that identifies itself as a correct leader node, broadcasting a leader packet that identifies itself as a correct leader node; and
vi) the changing step includes the step of the nodes using the leader packets to converge to an agreement on one of the nodes as the correct leader node.

18. A program storage device according to claim 14, wherein the method comprises the further steps of:
under steady state conditions, a correct leader node broadcasting a packet at defined times identifying itself as a correct leader node; and
if the non-leader nodes do not receive said packet within a defined period of time, the non-leader nodes electing a new correct leader node; and wherein
the step of electing a new correct leader node includes the steps of:
i) each of the nodes maintaining a time stamp and sequence number, and each node refreshing its time stamp and sequence number each time the node receives said packet; and
ii) if the time stamp of one of the nodes is not refreshed within said defined period of time, said one of the nodes identifying the current leader node as failed.
